(19) United States
(12) Patent Application Publication
(10) Pub. No.: US 2009/0186326 A1
(43) Pub. Date: Jul. 23, 2009

(54) Training and Educational System and Method for Training with Improved Follow Through

(76) Inventor: George Ishee, Atlanta, GA (US)

Correspondence Address: Kunzler & McKenzie, 8 EAST BROADWAY, SUITE 600, SALT LAKE CITY, UT, 84111, US

(21) Appl. No.: 12/350,483

(22) Filed: Jan. 8, 2009

Related U.S. Application Data
(60) Provisional application No. 61/021,938, filed on Jan. 18, 2008.

(51) Int. Cl. G09B 19/00; G09B 7/00

(52) U.S. Cl. 434/238; 434/323

(57) ABSTRACT

A system and method for delivering a training course includes dividing the course up into training segments of manageable lengths for taking in by recipients on regular and/or frequent bases. The training segments are included with email or other electronic messages. The messages may include hyperlinks representing options for responding to an invitation to run the training segments associated with the messages. When the recipient chooses to run and complete a training segment, the system moves to a subsequent message and segment. If the recipient refuses to run the training or delays doing so, the system sends increasingly urgent messages and/or initiates personal contacts to require accountability. Status messages may also be sent to others, including supervisors, for example. A measure of flexibility in timing is made available to the recipient while requiring a heightened level of accountability so that the recipient has a greater probability of completing the training courses.

### CROSS-REFERENCES TO RELATED APPLICATIONS

This application claims priority to U.S. Provisional Patent Application No. 61/021,938 entitled “A TRAINING AND EDUCATIONAL SYSTEM AND METHOD FOR TRAINING WITH IMPROVED FOLLOW THROUGH” and filed on Jan. 18, 2008 for George Ishee, which is incorporated herein by reference.

### FIELD OF THE INVENTION

This invention relates to training and educational programs and more particularly relates to delivery of training programs.

### BACKGROUND

### DESCRIPTION OF THE RELATED ART

A multitude of self-help training and educational seminars are presented to a wide variety of audiences around the world on an ongoing basis. Speakers on lecture circuits present techniques and concepts that can help individuals and groups in business, governmental, and social enterprises. Instructors in formal and continuing education courses present material for the benefit of recipients. The presentations and courses in which these presentations are delivered may be generally considered training programs or training courses. Unfortunately, with current training and educational delivery methods, most of the content delivered in these programs and courses is lost and forgotten long before it has any chance of being learned and applied by the recipients.

Attempts have been made to facilitate training such as by delivering email reminders to participants in a self-coaching program in order to encourage the participants in the program, for example. These programs often have a focus on getting the participants to develop value statements and set goals. Thus, the participants actually control the content of material that is the subject of the programs to some extent. Often the participants have extensive control over the pace of the training, and there is little or no penalty for delaying or not completing the training. Premapped coaching messages may be delivered to the participants by an auto-responder, for example.

In other programs participants log onto a web site for their training. Follow up messages may be sent via email to provide reminders or links to other web pages for relevant information. The reminders as well as steps in the training may be timed and delivered according to a schedule. Some training programs may include “push” emails or telephone calls to give reminders of things to do in relation to the training programs. Many programs enable voluntary feedback by participants, but move through delivery of the program independent of any feedback.

Training programs have a wide variety of subject matter and content. The techniques and concepts are innumerable. There is a wide variety of styles and methods for delivering the programs, many of which are lacking in encouraging follow through in learning and completion of the training programs or courses.

### SUMMARY OF THE INVENTION

There is a core problem with the training methods of the past. This core problem involves a lack of accountability throughout the courses and applications. Most of the content of the training and educational is pre-mapped out, then delivered to the recipients for them to complete themselves. That is, the recipient takes the books, tapes, CD's, DVD's, etcetera home and the program leaves it up to the recipient to complete the coursework on his or her own. Sometimes, the recipient has the option of attend a live training. In any case, there is little or no follow up or accountability. As such, when the recipient leaves, there is no follow up mechanism to help him or her retain the material that has been presented.

A new method is required to guide the recipient through the process giving joint accountability to the program and the recipient in order to better ensure the program is completed. If an action is made mandatory either directly by the program or as a response mechanism of the program in response to an action taken by the recipient, and if such action is required at every step of the way, then the recipient is more likely to complete the program. If no action is taken the recipient, then alternative accountability actions can be implemented by cause and effect mechanisms in the program. For example, in one embodiment, when the program sees no action, the system sends several reminders and then forwards the results to a live coach to convert, at least in part, to live coaching.

From the foregoing discussion, it should be apparent that a need exists for an apparatus, system, and/or method that improves training receipt or learning follow through with improved accountability, which may include joint accountability. Beneficially, such an apparatus, system, and/or method would raise a level of accountability for a person who is a recipient or potential recipient of a training program or training course, and require him or her (or the program) to make decisions and choices that will provide a greater likelihood of completing a training program or training course for which the recipient has signed up or in which the recipient is entering. At the same time, the apparatus, system, and method would enable the recipient to maintain a measure of control of the pace at which he or she completes lessons or training segments, as long as sequenced actions are taken. In one embodiment, the process continues even when action is not initially taken by the recipient. In this case, the system may respond by determining a new set of actions to be taken.

The present invention has been developed in response to the present state of the art, and in particular, in response to the problems and needs in the art that have not yet been fully solved by currently available training and coaching programs. Accordingly, the present invention has been developed to provide an apparatus, system, and method for improving learning or training follow through by raising a level of accountability for the recipient, and for requiring the recipient to make decisions and actively select options for the purpose of increasing assurances that the recipient will complete the training program or training course. If the recipient does not take action, the system takes actions such as by presenting the recipient with options and/or delivering results appropriate for the option(s) selected by the recipient. Thus, the apparatus, system, and/or method overcome many or all of the above-discussed shortcomings in the art.

The apparatus in accordance with an embodiment of the present invention includes a signal bearing medium tangibly embodying a program of machine-readable instructions executable by a digital processing apparatus to perform operations to promote follow through in learning or receipt of training. The apparatus is configured to improve training or learning follow through, and may be provided with a plurality of modules configured to functionally execute the necessary operations of sending a message that encourages continual and active feedback from a recipient receiving the message to a training provider or provides feedback to the training provider automatically when no active feedback is provided, and including a training segment in the message. These modules in the described embodiments may include the signal bearing medium and the machine-readable instructions configured to execute operations of one or more of delivering a training course in which the training course has a plurality of training segments and including the training segments with a plurality of messages. It is to be understood that the apparatus may not have modules. Nevertheless, the apparatus may be configured to execute the operations without modules.

A system of the present invention is also presented to improve follow through in learning or receipt of training. The system may be embodied by one or more features of the apparatus in combination with other components. In particular, the system, in one embodiment, includes the apparatus described above in combination with one or more servers or computers. In an alternative embodiment, the system may include a plurality of servers on which content and/or applications of training providers reside, one or more networks, and a plurality of devices that provide interfaces for recipients of the training.

A method of the present invention is also presented for improved follow through in training or learning. The method in the disclosed embodiments substantially includes the steps necessary to carry out the functions presented with respect to the operation of the apparatus and system described herein. On the other hand, all the embodiments of the methods do not require an apparatus or system. In one embodiment, a method of training includes sending an electronic message to a person or recipient and including a training segment with the message. The method also comprises including an active feedback mechanism with the message and prompting the recipient by the message to provide feedback through the active feedback mechanism. In one embodiment, the feedback mechanism includes an option for running the training segment. In this embodiment, the method further includes running the training segment in response to selection of the option by the recipient.

In another embodiment, the training segment has an evaluation mechanism for determining the recipient's understanding of material in the training segment. In this embodiment, the method further includes evaluating the recipient utilizing the evaluation mechanism after running the training segment. In this regard, the method further includes sending a new electronic message with a subsequent training segment when the evaluation mechanism shows understanding of the material. On the other hand, the method in this embodiment includes sending a message with a previously sent training segment when the evaluation mechanism shows lack of understanding of the material by the recipient that is being evaluated.

In other embodiments, additional or alternative options are available. For example, in one embodiment, the feedback mechanism includes an option for reviewing a previous training segment. In another embodiment, the feedback mechanism includes an option for pausing or postponing training. The method in this embodiment further includes at least one of pausing or postponing presentation of the training segment in response to selection of the option for pausing or postponing by the recipient. Pausing or postponing may include an option for the recipient to set a specific time period for pausing. In this embodiment, the method further includes sending a message of heightened urgency in response to pausing or postponing training by the recipient, or when the recipient fails to select any of the options.

In another embodiment, the method includes delivering a training course in which the training course is adapted to be delivered with a plurality of messages and the training course includes a plurality of training segments. In this embodiment, delivering the training course includes delivering and prompting a recipient to run, review, or complete each of the training segments. More generally, the recipient is required to take action in some form. In this embodiment, the method may include selecting a predetermined message and selecting from among the training segments based on the feedback from the recipient.

In another embodiment, the method includes promoting accountability by requiring participation and feedback in order to progress through the training segments and complete the training course. In this embodiment, the method includes communicating the requirement to participate, at least in part, through the messages.

In one embodiment, the active feedback mechanism includes a form of feedback such as but not limited to clickable link. In this embodiment, the method further includes automatically notifying a training provider when the recipient has accessed the training segment such as by clicking on the clickable link. Alternatively or additionally, the method may include automatically notifying a training provider when the recipient has paused or postponed the training such as by clicking on another clickable link associated with this option. In one embodiment, the active feedback mechanism includes a plurality of active links dynamically embedded in the message. The plurality of links may include at least two of a mechanism that runs the training segment, a mechanism that pauses the training, a mechanism that reviews a previous training segment, and a mechanism that refuses to run the training segment. Thus, a recipient can select any of the active links.

In one embodiment, the method includes a passive feedback mechanism. The passive feedback module functions such that no response by the recipient within a predetermined period of time is passive feedback. In this embodiment, the method further includes automatically causing a message to be sent to a training provider in response to the passive feedback. In this embodiment, the method may further include one or more of sending contact information of the recipient to the training provider and the training provider calling the recipient by phone to resolve concerns that are inhibiting the recipient from running the training segment.

In other embodiments of the invention, a method of supporting training or educational self improvement includes sending an email, another type of electronic communication, or some other form of communication having a message and a training segment, and an active feedback mechanism included with the message. These embodiments may also include at least one of prompting the recipient by the message to provide feedback through the feedback mechanism and automatically providing feedback that no response has been received when the recipient does not respond within a predetermined period of time.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram showing operations of embodiments of a method of the present invention;

FIG. 2 is a diagrammatic view showing an example of a system in accordance with an embodiment of the present invention;

FIG. 3 is a diagrammatic view showing an example of a system in accordance with another embodiment of the present invention;

FIG. 4 is a schematic block diagram illustrating one embodiment of an apparatus in accordance with the present invention;

FIG. 5 is a block diagram of an embodiment of a method of receiving a training course;

FIG. 6 is a block diagram of another embodiment of a method of receiving a training course; and

FIG. 7 is a block diagram of another embodiment of a method of receiving a training course.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any manner in one or more embodiments. In the following description, numerous specific details are provided, such as examples of programming, software modules, recipient selections, network transactions, database queries, database structures, hardware modules, hardware circuits, hardware chips, etc., to provide a thorough understanding of embodiments of the invention. However, the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

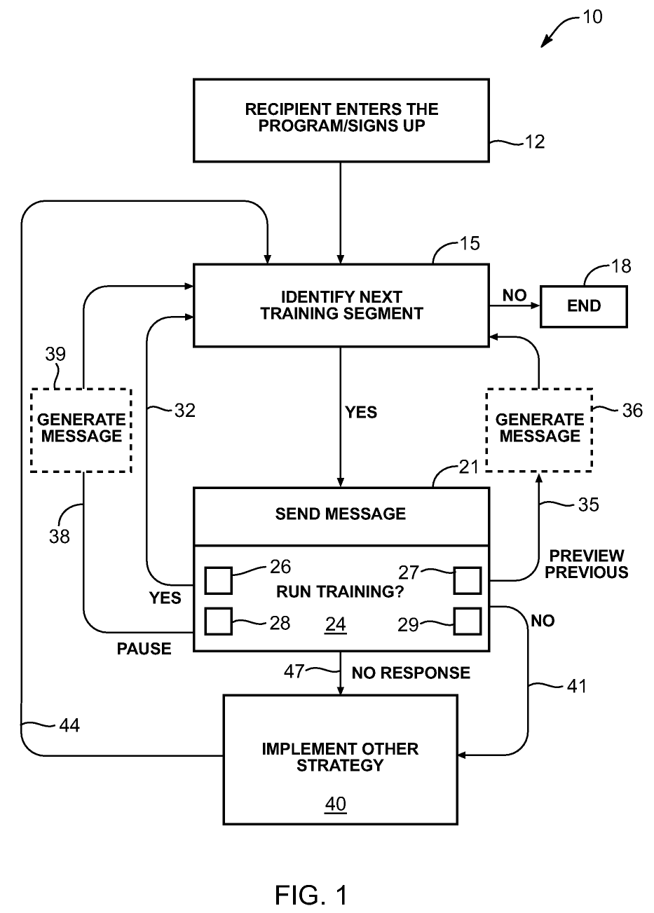

FIG. 1 is a block diagram showing operations of an embodiment of a method 10 of the present invention. The method 10 is an example showing operations that may be executed in a process of delivering a training program or training course. For example, a person who is to be a recipient of the training program or training course signs up or otherwise enters the program, as indicated at 12. A system of the present invention identifies the next training segment to be sent to the recipient, as indicated at 15. If the recipient is new to the training program, then the training segment will be a first training segment in a series of training segments. If the recipient has successfully received and run all of the training segments of the training program or course, then the system is unable to identify a next segment and the system executes an operation to end the process of delivering the training program or training course as indicated at 18.

When the system identifies a training segment to be presented, the system executes an operation to send a message that includes the training segment that has been identified, as indicated at 21. The message contains an invitation to run the training segment, as indicated in block 24. The message also contains one or more options 26, 27, 28, 29 from which the recipient may select in response to the invitation. In one embodiment, the options may be presented to the recipient as clickable links or soft buttons within the email message. Alternatively, the options may include any other feedback mechanism, such as speech to text, brail terminals, etc. The clickable links are represented in FIG. 1 by the squares labeled 26, 27, 28, and 29. Option 26 is an acceptance of the invitation to run the training segment. Selection of this option 26 by the recipient immediately runs or enables the recipient to immediately run the training segment, and may automatically notify a training program provider that the recipient has run the training segment or has accepted the invitation to run the training segment. It is to be understood that in some embodiments selection of this option may open an attachment or connect the recipient to a website that contains the segment. In either case, the training segment may be automatically run by selecting option 26. Once the training segment has been successfully completed, the system is updated so that the next training segment in the series will be identified and included with a subsequent message to be sent to the recipient. Then the system executes an operation to return to the operation of identifying the next training segment 15 in the process of delivery, as indicated by line 32.

Alternatively, if the recipient selects option 27 in order to review a previous training segment, then the system returns the process, as indicated by line 35, to the identifying operation 15 with instructions to select the previous training segment in the series. The system may include a mechanism for selecting a particular one of the training segments or may simply select the immediately previous segment in the series. The system may also be automatically updated with the information that the recipient has delayed running a training segment by requesting the previous training module. This update may also automatically cause the system to send a message that communicates a heightened level of urgency to the recipient, as indicated at 36, either immediately or with the next message that is sent. Additionally or alternatively, depending on how many delays by pausing, postponing, and/or reviewing previous training segments, the system may automatically prompt using other strategies 41, such as contacting a training representative to make a telephone call to the recipient to resolve any concerns that may be inhibiting progress through the training course. In any case, the process of delivery of the training program is permitted to continue.

Further alternatively, if a recipient responds to the invitation by selecting option 28 in order to pause or temporarily postpone running the training segment, then the system returns, as indicated by line 38 to the operation of identifying the next training segment 15 with no changed status on the number of segments completed so that in the next identification operation, the system will select the same segment that was identified for delivery with the previous message. However, the system may be automatically updated to send a message having increased urgency to the recipient, as indicated at 39, either immediately or in the next message. On the other hand, the system may execute operations to take a different course of action and notify a representative of the training program, as indicated at 41. The level of urgency that is communicated, including communicating with the representative, may be implemented in accordance with a predetermined set of rules and depending on a number of times the recipient has selected a review of a previous training segment 27 and/or paused the process of delivery of the training program 28, for example.

If the recipient selects option 29 in order to decline the invitation or indefinitely postpone running the training segment, then the system is automatically updated and caused to pursue another course of action including different operations or to implement another strategy 40, as indicated by line 41. For example, the operation of implementing another strategy 40 may include automatically contacting a training program representative to prompt a telephone call or other communication from the program representative to the recipient to determine any concerns that may be inhibiting the recipient from progressing in the training program. In any case, the system returns to the process of delivering the training program, as indicated by line 44 once any questions or concerns have been resolved and the recipient is persuaded to take the next step in completing the program. Thus, in some embodiments, the options 26, 27, 28, and 29 and associated structure and function, at least in part, form an active feedback mechanism.

Embodiments of the present invention also include a passive feedback mechanism, and FIG. 1 shows a passive feedback path indicated by line 47. The process moves along this path when no option is selected within a predetermined period of time. Thus, the system and methods in accordance with embodiments of the present invention require active feedback, or automatically respond to the passive feedback. As with the options discussed above, when a recipient ignores or does not respond to the invitation to run the training segment, progressively more urgent messages may be sent to the recipient. Alternatively or additionally, the representative is contacted automatically so that the representative can contact the recipient directly in order to help resolve concerns that the recipient may have.

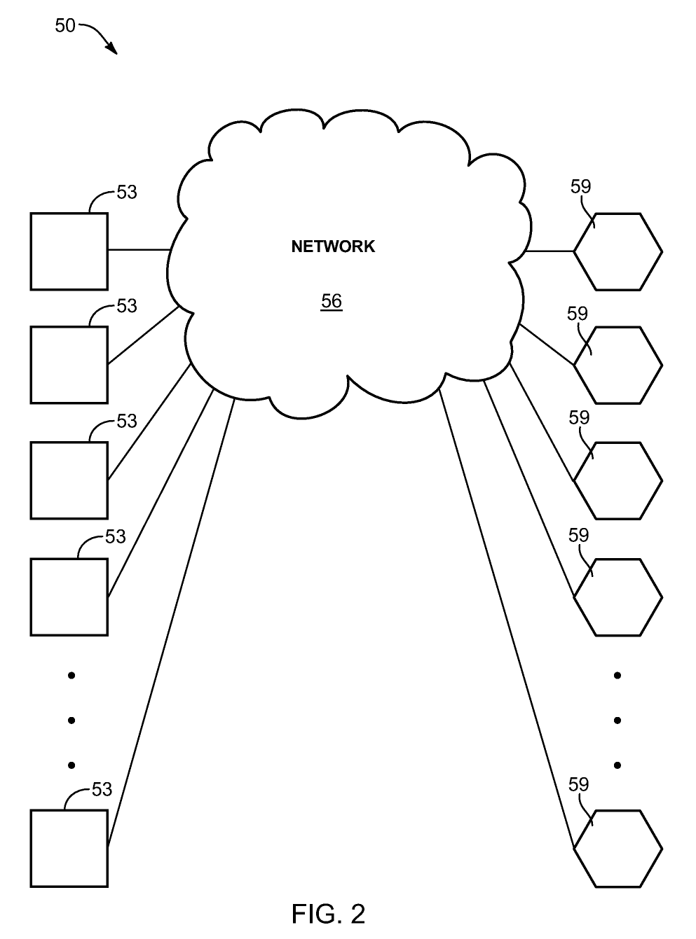

FIG. 2 is a diagrammatic view showing an example of a system 50 in accordance with an embodiment of the present invention. The above described method may be implemented in the system 50 or in a variety of other systems made up of other components that replace or supplement the system 50. Nevertheless, system 50 includes one or more servers 53 on which training programs may be stored and/or executed. One or more of the servers 53 may also have the training program delivery application thereon. The training program delivery application may include software that is stored and executed from one of the servers for some or all of the training programs. Alternatively, a respective copy of the training program delivery application may be loaded onto the servers 53 for each training program. A network 56 may be any of a variety of networks or combinations of networks including one or more of the Internet, a wide area network, a local area network, and a wireless network. The servers 53 and the training programs that they hold are connected to devices 59 with which the recipients interface via the network 56. The devices 59 may include one or more of a personal computer or other computer, a personal digital assistant (PDA), a cell phone, and other devices. The devices 59 are capable of delivering a message having a training segment to the recipients. As indicated in FIG. 2, any number of training programs or courses may be delivered by the system 50 and methods described herein. The number of training programs may only be limited by physical capacity of the servers 53, network 56, and/or training program delivery application. Any number of devices 59 can deliver the messages and training segments in accordance with the present invention. The number of devices 59 and recipients may be much higher than the number of training programs since multiple recipients can receive the same training program substantially simultaneously.

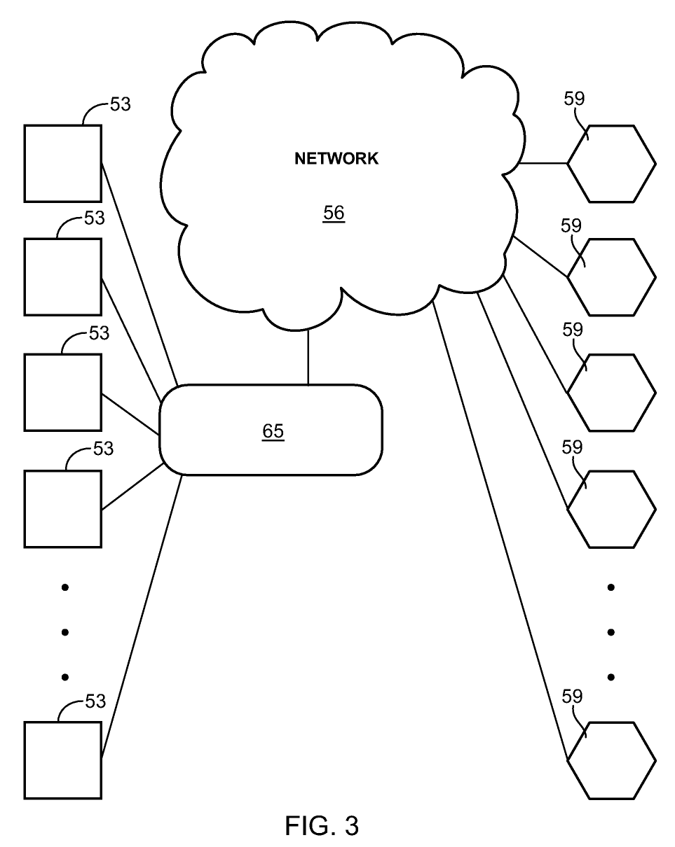

FIG. 3 is a diagrammatic view showing an example of a system 62 in accordance with another embodiment of the present invention. The system 62 is similar to the system 50 and may include servers 53, network 56, and devices 59, as described above. However, the system 62 has a server 65 for storing and executing the training program delivery application for a plurality of training programs on the servers 53. As shown in FIG. 3, the servers 53 may be connected directly or indirectly to the server 65. In one embodiment, the servers 53 are connected to server 65 through a network such as the Internet. In this embodiment, the server 65 may be considered to be part of the network 56.

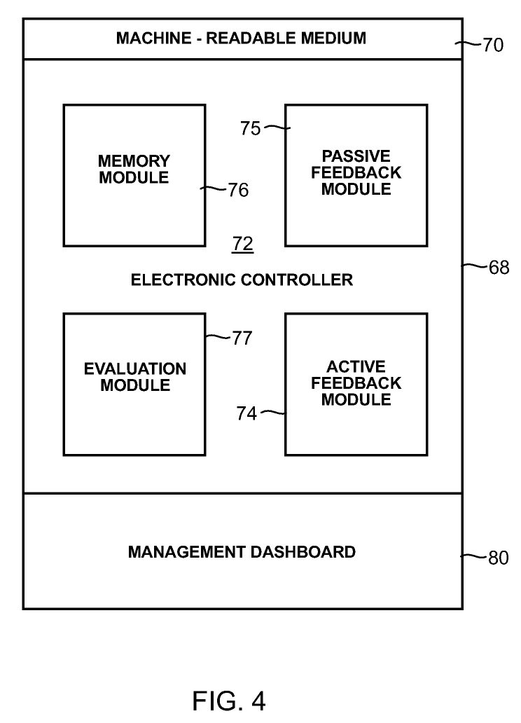

FIG. 4 is a schematic block diagram illustrating one embodiment of an apparatus 68 in accordance with the present invention. It is to be understood that the apparatus 68 may include one or more of a machine-readable medium 70, a program of machine-readable instructions capable of being stored on the machine-readable medium 70, and a digital processing apparatus or machine 72. The machine-readable medium 70 may include any of a variety of memory and related devices for storing the program, including machine-readable instructions. The digital processing apparatus or machine 72 is also labeled an electronic controller in the embodiment shown in FIG. 4. The application for delivering the training programs includes one or more of the machine-readable medium and the program of the machine-readable instructions. The application for delivering the training programs also includes modules for performing functions and operations among the operations of the methods of the present invention. Thus, the apparatus 68 in combination with the application for delivering the training programs can include one or more of an active feedback module 74, a passive feedback module 75, a memory module 76, and an evaluation module 77, for example. In this embodiment, these modules form part of an active feedback mechanism, a passive feedback mechanism, a memory mechanism, and an evaluation mechanism, respectively. These modules act to perform the operations of the respective mechanisms of which they are a part. Thus, follow through in receiving training and learning is facilitated.

Referring to FIGS. 3 and 4, the apparatus 68 may form part of the server 65 or another server that makes the application for delivering the training programs available to owners and/or users of the training programs on servers 53, for example. The apparatus 68 may further include a management dashboard 80 that is operably placed between the training programs and the application for delivering the training programs. This management dashboard 80 may include software, and may alternatively be located on another server. In any case, the management dashboard 80 tracks and reports data to one or more of an owner of the training program delivery application and the owner of the training programs.

In one embodiment, the invention is an Internet-based self-improvement application. The program can utilize lessons or training segments from circuit speakers, continuing education instructors, lecturers, and/or other promoters. The lessons or training segments may include self-improvement or group improvement-type presentations that form at least part of the training programs or courses. The application may transmit those training segments over the Internet through email or other communication applications, for example. The transmission of the training segments may include one or more of video, text, and interactive programs. When utilizing email as the delivery medium, any of a number of protocols and applications that are known or not yet discovered may be implemented without departing from the spirit and scope of the invention.

In other embodiments, the invention may be implemented with any of a variety of other delivery technologies. For example, messages and training segments may be delivered using short message service (SMS) protocols, applications and devices for a delivery mode often called “text messaging” and used for mobile text messaging. Another protocol is multimedia messaging service (MMS), which allows sending messages that include images, audio, video, and rich text. This mode of operation enables streaming and storing capabilities, as they apply to the embodiments of the present invention. These protocols are mainly deployed in cellular networks. Other similar modes may include mobile instant messaging and mobile email with any accompanying variations in their protocols.

Other technologies lend themselves to sending and receiving messages and training segments in accordance with embodiments of the present invention. For example, instant messaging (IM) technologies, which were developed with a large variety of applications, may be utilized for implementation of embodiments of the present invention. Still another technology is really simple syndication (RSS), which is a family of Web feed formats used to publish frequently updated content such as blog entries, news headlines or podcasts. RSS makes it possible for people to keep up with their favorite web sites in an automated manner, and thus provides another possible mode for sending and/or receiving messages and training segments in accordance with embodiments of the present invention.

Still further, it is to be understood that in a basic form, one embodiment of the present invention need not be automated through electronic or digital devices and networks. Rather, the methods could be implemented in a live setting, classroom setting, or through analog communication. Any and all of the modes and mediums of communication disclosed herein, whether known or not yet discovered, are considered to be within the spirit and scope of the present invention. However, these modes and mediums are examples only, and are not limiting. Thus, methods and systems of the invention may be utilized for delivery of training segment content to mobile devices via test, streaming video or store, and/or forward capabilities, as well as in person.

Each training segment may belong to a group of training segments that make up the training program or course, and the training segments may be sent or delivered to a person or the “recipient” in messages with one training segment per message, for example. On the other hand, it is possible to have more than one training segment or no training segments with any given message. In one example, a training course may be split into a month long program with one email being sent per day. The email may have a clickable hyperlink button linked to a URL in order to access a website and/or a particular training segment on the website. Alternatively, the email message may have the content in the body of the message or included as an attachment. Examples of numbers of training segments in a training course may be in ranges from two to three hundred sixty-five, or more. In another example, the number of training segments may be from two to thirty-one. Any number of training segments within these ranges is also available. A duration of the training segments may be from three minutes to one hundred eighty minutes. In another example range, the duration of the segments may be from five to fifteen minutes. Segments having other durations or ranges of durations within or without the example ranges may also be sent with messages in accordance with embodiments of the present invention.

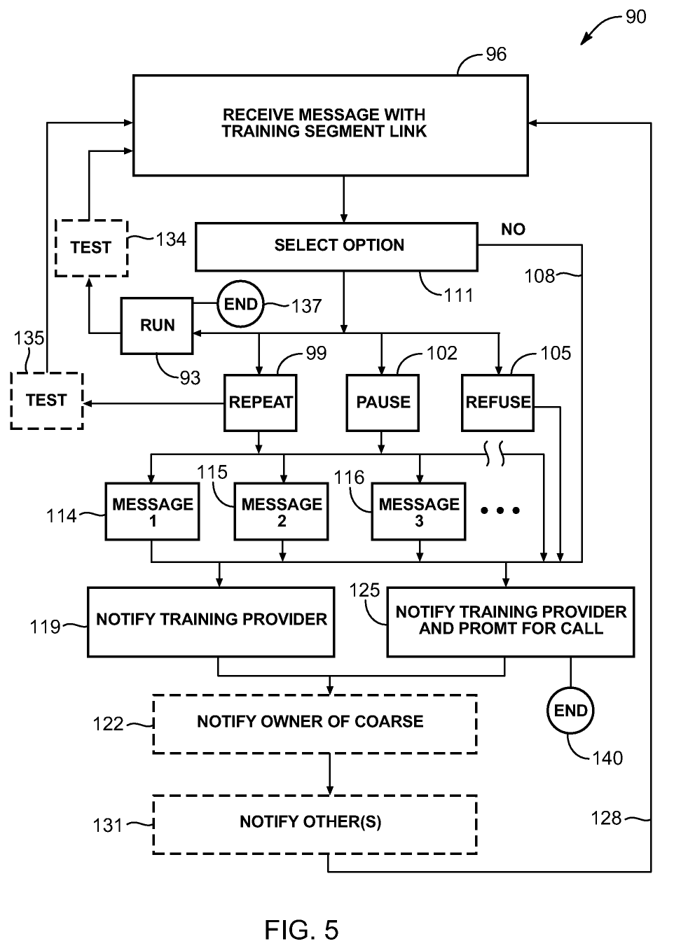

FIG. 5 is a block diagram of an embodiment of a method 90 for receiving a training course. In one embodiment, accessing the training segment 93 is only one of a plurality of options for the person who receives a message 96 (i.e., a recipient). Other options may include one or more of repeating a previously presented training segment 99, pausing the training program 102, refusing to run the training segment 105, and ignoring the message indicated by connecting line 108. The message received prompts the recipient to select an option 111. Accessing the training segment 93, pausing the training program 102, refusing to run the training segment 105, and repeating a previously presented training segment 99 may be associated with hyper links dynamically embedded into an email or other message. These hyperlinks provide an active feedback mechanism that automatically selects one of a plurality of predetermined messages 114, 115, 116 to send to the recipient, and notifies a training provider 119 and/or owner 122 of a training program of the option selected.

When the recipient selects the link to pause the program 102, feedback in the system can automatically cause a message of increasing urgency to be sent the following day, for example. If the recipient requests a review of a previous training segment 99, then the program can cause the system to proceed in a normal sequence thereafter. If the recipient requests reviews 99 above a predetermined number or percentage of the training segments, then the program can cause the system to send any number of messages 114, 115, 116, . . . of increasing urgency to the recipient and/or the training provider. This may be achieved by incrementing a counter variable each time a training segment is repeated 99, and/or each time the course is paused 102. If the recipient does not respond to a message within a predetermined amount of time, as indicated by connecting line 108, then the program can automatically cause the system to notify the training provider 119/program owner 122. If for any reason, the recipient is not progressing in a manner that will enable acceptable completion of the training course, then the training provider may be automatically notified 119 and/or provided with the recipients contact information. The training provider or a human operator representing the training provider may call the recipient 125 to explore reasons for lack of progress, and to help remove inhibitions so that the recipient is free to move forward toward completion of the training course again, as indicated by connector line 128. Informing additional individuals and/or coaches regarding the recipient's progress or lack of progress may further motivate the recipient to run the training segments and progress through the training course. For example, the messages 114, 115, 116 or corresponding reports may be sent 131 by email (or other form of communication) to one or more of a coach, a supervisor, a VP, and/or a President of the company of the recipient.

In an example of one embodiment of the method in practice, the recipient receives the email message 96, selects the link 93 that actuates the next presentation in the course, and takes in the training segment. At the end of the lesson there may be a test 134 that determines if the recipient has mastered the subject matter. If so, then a counter variable is incremented and the recipient will be moved to the next lesson when presented with the next message 96 in a loop. If not, then the counter variable is not incremented and presentation is repeated the next day, for example. The same may be true for repeating training segments 99 in which the system requires a test 135 to determine whether the repeated material has been mastered before incrementing the counter variable and returning to the operation of sending a subsequent message (receiving the message 96 by the recipient.) Once all of the training segments have been successfully run 93 and/or the tests have been passed, then the program exits and ends 137.

The messages and training may be delivered on a random or irregular basis, or may be delivered regularly. The frequency and regularity with which the messages are sent 96 may be determined by the training provider. Alternatively, the frequency may be established by the training program itself, or may be automatically determined by the delivery application in accordance with embodiments of the present invention. The frequency may be once a day, or the messages with the training modules may be delivered on each business day, for example. Alternatively, the messages and training may be delivered on a weekly or bi-weekly basis. The recipient can pause the program 102 at any time for a specific number of days. In one embodiment, the recipient may have one free day for ignoring the message, after which he or she will get a reminder in the form of one of the messages 114, 115, 116 the following day. After that, if the recipient does not make acceptable progress, then the program causes the system to contact the recipient in a continually more aggressive and urgent manner until finally a person representing the training provider contacts the recipient 125. There is a possibility that the recipient will drop out of the course before its completion, as indicated at 140. However, this is generally only a last resort when all the options of motivation have been exhausted, and only after verbal communication with the recipient has failed to remove obstacles to progression through the training program. This, of course, may occur when the recipient has an emergency or a major change in his/her life such as a change of job or upon contracting a chronic illness.

Systems and methods in accordance with embodiments of the present invention may have little or no flexibility in choice by the recipient for options of content to be included in the training course. Rather, the systems and methods of the present invention may take existing training programs and provide a sequential delivery process of that program with little or no deviation from the program in its predetermined form.

In one embodiment, the systems and methods send an email to the recipient with a training segment having predetermined content in the email, and require the recipient to take action by selecting an embedded link. This gives control of the timing to the recipient. If the recipient does not select a response, then the training program may be halted, put on hold, and the process of delivering the training program may be caused to follow a different set of instructions until the recipient responds.

In another embodiment, the system and methods require the recipient to continue the program at a predetermined rate or in accordance with a predetermined set of rules. These rules may include putting the training program on hold when the recipient does not respond. As shown in FIG. 5, the system and method in one embodiment automatically pauses the program when the recipient does not actively select 111 an option within after a set time limit, (for example, midnight of the same day the message was delivered.) If the recipient does not respond as indicated by the connecting line 108, then action is automatically taken on behalf of the recipient by the system and method. For example, the system and method may execute operations as though the recipient had actively paused 102 the training program. These operations may include contacting one or more of the training provider 119/125, program owner 122, supervisor(s) 131 of the recipient, etc.

Systems and methods in accordance with one embodiment send email or other messages based on a sequence of predetermined operations. In any case, the systems and methods require accountability. The systems and methods provide a plurality of choices or options that enable the accountability of the recipient, and then require him or her to take action by selecting one of the options.

The systems and methods in accordance with one embodiment enable a web-based delivery application. Alternatively, the application can be hosted on an intranet network of a company, for example. The network may be wireless, wired, or a combination of wireless and wired. The application can be privately labeled on one or more servers in which the application is held. Alternatively, the company can private label the application including any branding or messaging implemented by the application.

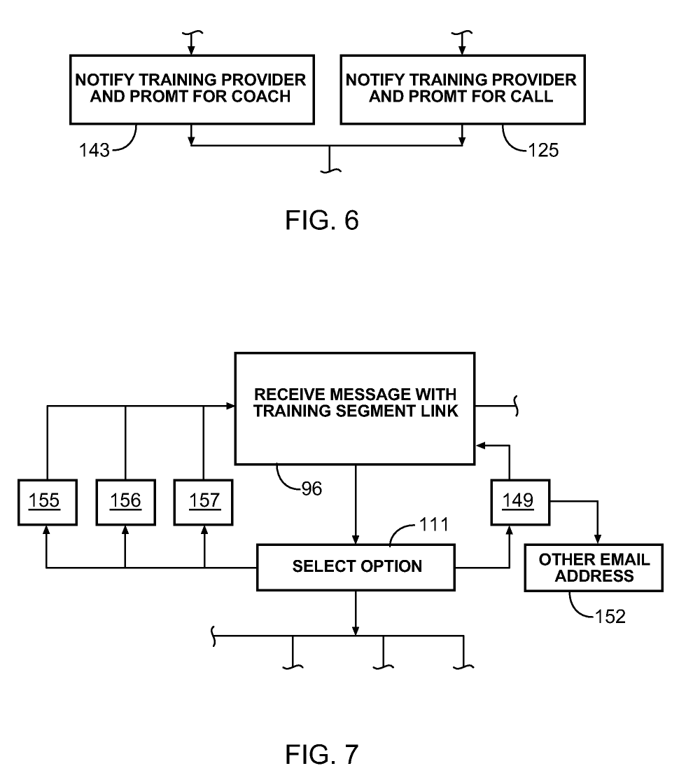

FIG. 6 is a block diagram depicting another embodiment of a method of receiving a training course. With regard to FIG. 6, a platform for the system and method in accordance with an embodiment of the present invention may include a coaching program. Embodiments of the present invention include a delivery application for delivering pre-determined training courses or training programs, some of which may include coaching. Some programs or courses may implement coaching at different stages or under particular circumstances. For example, coaching may occur when the recipient does not respond to the messages by actively selecting an option or by actively selecting not to continue the training course. On the other hand, the systems and methods in accordance with embodiments of the present invention can be utilized to deliver a coaching program when indicated by the training course. As shown in FIG. 6, the operation of notifying the training provider 119 in FIG. 5 may be replaced or supplemented by the operation of notifying a coach 143. In some cases the training provider is also the coach. Furthermore, the coach or another person can be prompted to call the recipient when needed, such as at times of heightened urgency. No matter what training program or course, the systems and methods in accordance with embodiments of the present invention provide a delivery method for the training course that facilitates increased accountability. After the prescribed coaching, the system proceeds in its regular loop returning to running a training segment 93, testing 134, or sending/receiving a message 96, as shown in the block diagram of FIG. 5. All or part of the operations shown and described with regard to FIG. 5 may be undertaken as part of the method of FIG. 6.

The systems and methods of the embodiments of the present invention require the recipient to respond unless he or she wishes to be repeatedly and more forcefully prompted to respond, such that responding to the prompts is not considered to be optional, but is required. These prompts are configured and presented persistently to induce the recipient to complete each training segment and the overall training course.

FIG. 7 is a block diagram of another embodiment of a method of receiving a training course. In accordance with this embodiment, the system and method delivers an email with content from the training course, (also referred to herein as the lesson or training segment.) This and other training segments are provided with email or other messages on a pre-defined time line. The recipient is then required to select one of the options embedded in the message, as described herein. By selecting an active link associated with one of the options, the recipient controls his or her rate of progress by delaying, repeating, or moving through the content to move the process to the next step or training segment, also as described herein. If the recipient does not select an option within a predetermined period of time, then the system immediately returns, as indicated by connecting line 146, to sending another message 96 and/or the system initiates a series of progressively more urgent messages and/or personal contacts. After decrementing a counter variable, as indicated at 149, the system identifies the immediately previous training segment to be sent to the recipient instead of the training segment that the recipient ignored. The new message thus includes a link to select in order to receive the previous training segment. Alternatively or additionally, the system initiates a message having an urgency commensurate with the delay or potential delay that may be caused by the passive selection of no response. After a predetermined number of reminders to which the recipient does not respond, the system can send an email to a different email address 152 in an effort to notify the recipient of the status of the progress in the training program.

In one embodiment of the system and method, all the messages that are sent to the recipient also deliver training segments. These messages include active feedback mechanisms. For example, when implemented with email messages, the messages contain training segment material or have links to the training segment material. Additionally, the email message may have one, two, three, or more links in the message, as described herein. It is to be understood that opening or running the training segment by clicking an active link may send feedback to the system, as well as running the training. The message prompts the recipient to select one of the active links associated with respective options in response to a system prompt requesting that the recipient run the program. The options may include choices such as yes, no, pause and/or repeat. Selection of each of the options causes a different action to be executed by the system, such as to increment 155, decrement 156, or leave a counter variable the same 157. The action taken by the system may be suspended until the recipient has taken a test, (such as test 134 or 135 shown and described with respect to FIG. 5) to determine if he/she has mastered the material of the particular training segment. When the recipient passes the test, then the method returns to the operation of sending/receiving a message 96. In the case where the recipient does not select one of the options, the system eventually takes other actions that progress toward notifying the training provider and/or owner of the program of the status of the recipient in his or her progress toward completion of the training course, as described herein with regard to FIGS. 5 and 6. This enables the training provider/owner to follow up and contact the recipient to determine what will persuade him or her to diligently participate in the training program. All or part of the rest of the methods of FIGS. 5 and 6 may be implemented in the embodiment of the method of FIG. 7 without limitation.

The system and method in accordance with embodiments of the present invention gives control to the recipient regarding when the next lesson or training segment will be run. At the same time, the system and method require the recipient to take action and reply to the prompts in the messages in order to move the training program forward, and to avoid further and more urgent messages prompting action. Thus, the system and method may deliver an existing training course that is available elsewhere in the market, and help the recipient complete the program unlike the courses available on the market. In any case, the system and method have accountability built in and controlled, at least in part, by the recipient. If the recipient does not do anything, then the system will cause something else to happen that has the effect of not letting the recipient escape responsibility.

The systems and methods in accordance with embodiments of the present invention take content from an existing training course or program of an existing training provider, and manage delivery of the content to the recipient. Some or all of the decisions for content and time lines may be predetermined and built into the existing training course or program. Alternatively, they can be determined and/or selected by an owner of the course or program. The recipient has the ability to control the delivery at each stage of the course. That is, he or she decides when to run and complete each training segment as they are delivered. On the other hand, once the recipient signs up or enters the program for a particular training course, the systems and methods in accordance with the present invention help the recipient to keep his or her commitment by requiring active responses at each stage of the training.

Embodiments of the systems and methods of the invention also help to promote or market the systems and methods to program owners and potential recipients. That is, providers of motivational or self-help programs will be encouraged to use the systems and methods when they come to appreciate the valuable accountability and other features that these systems and methods include. Training providers may approach any such owner of a training course and present the systems and methods of the present invention. The systems and methods will speak for themselves and show results based benefits of helping recipients to complete their courses.

Another marketing mechanism is to set up a free referral marketing and commission program. Individuals or companies may join the program and participate by using free programs and/or paid programs to receive training in accordance with embodiments of the method. After receiving the training, participants are permitted to vote. The votes are tallied, and the programs are rated accordingly. Thus, the available training programs are given ratings based on the votes received so that participants can identify and take advantage of high quality training courses. By referring additional individuals and companies the referrer receives a commission on direct referrals and on referrals of referrals up to five levels deep. Thus, there is an incentive to refer individuals and companies to the referral marketing and commission program, which causes the number of participant members of the marketing and commission program to grow. For training course owners, a requirement for membership may include sharing at least one product for free. Thus, the number of available training programs also grows. With the same standards of accountability applied to all the training courses, the training course owners are assured that their training courses are being promoted and supported, and that the service will be at the same high quality for the current and future training courses that they make available through the embodiments of the systems and methods of the present invention.

The system and method in accordance with one embodiment keeps the recipient on track to complete the training course or program, and then provides a report showing that the recipient completed the course or program. The report may be generated in accordance with data that is tracked by a management dashboard 80 like the one shown in FIG. 4, for example. The management dashboard 80 may be operably connected to a server that holds the training program and/or to a server that holds the application for delivering the training program. The application for delivering the training program implements embodiments of the method in accordance with the present invention.

In one embodiment, reporting capability is available at any point in time or in response to any of the events implemented in accordance with the systems and methods of the invention. Reporting can be accessed via the dashboard 80 to cause notices to be sent to one or more contacts. For example, reports with the data may be sent to one or more other contacts. An example would be when a recipient finishes a series of lessons, an email is sent to many other emails with the results, (e.g., the supervisor, the coach, the VP, and/or the President).

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of training, comprising:
sending an electronic message to a recipient;
including a training segment with the message;
including an active feedback mechanism with the message;
prompting the recipient by the message to provide feedback through the active feedback mechanism.

2. The method of claim 1, wherein the feedback mechanism includes an option for running the training segment, the method further comprising running the training segment in response to selection of the option by the recipient.

3. The method of claim 2, wherein the training segment has an evaluation mechanism for determining the recipient's understanding of material in the training segment, the method further comprising evaluating the recipient utilizing the evaluation mechanism after running the training segment.

4. The method of claim 3, wherein the method further comprises sending a new electronic message with a subsequent training segment when the evaluation mechanism shows understanding of the material, and sending a message with a previously sent training segment when the evaluation mechanism shows lack of understanding of the material by the recipient.

5. The method of claim 1, wherein the feedback mechanism includes an option for reviewing a previous training segment.

6. The method of claim 1, wherein the feedback mechanism includes an option for pausing or postponing training, the method further comprising pausing or postponing presentation of the training segment in response to selection of the option for pausing or postponing by the recipient.

7. The method of claim 6, further comprising sending a message of heightened urgency in response to pausing or postponing training by the recipient.

8. The method of claim 15, wherein sending the message further comprises utilizing at least one of: email, (SMS), (MMS), (IM) technology, and Really Simple Syndication (RSS) feed.

9. The method of claim 15, further comprising a training provider tracking data by a management dashboard.

10. The method of claim 15, wherein the active feedback mechanism comprises a plurality of active links dynamically embedded in the message, the plurality of links including at least two of a mechanism that runs the training segment, a mechanism that pauses the training, a mechanism that reviews a previous training segment, and a mechanism that refuses to run the training segment.

11. A machine-readable medium tangibly embodying a program of machine-readable instructions executable by a digital processing apparatus to perform operations to promote follow through in learning, the operations comprising:
sending a message that requires active feedback from a recipient receiving the message to a training provider or provides feedback to the training provider automatically when no active feedback is provided; and
including a training segment in the message.

12. The machine-readable medium and the machine-readable instructions of claim 11, wherein the operations comprise:
delivering a training course, wherein the training course has a plurality of training segments including the training segment; and
including the training segments with a plurality of messages including the message.

13. The machine-readable medium and the machine-readable instructions of claim 12, wherein the training segments are from three to fifteen minutes in duration, and wherein running each of the segments takes from three to fifteen minutes.

14. The machine-readable medium and the machine-readable instructions of claim 12, wherein:
there are from two to thirty training segments including the training segment; and
delivering the training course comprises running each of the training segments.

15. The machine-readable medium and the machine-readable instructions of claim 12, further comprising sending the messages regularly.

16. The machine-readable medium and the machine-readable instructions of claim 15, further comprising selecting a predetermined message, and selecting from among the training segments based on the feedback from the recipient.

17. The machine-readable medium and the machine-readable instructions of claim 12, further comprising:
promoting accountability by requiring participation and feedback in order to progress through the training segments and complete the training course; and
communicating the requirement to participate, at least in part, through the messages and through increasingly heightened urgency messages when the recipient does not run one or more of the training segments.

18. A method of supporting self improvement, comprising:
sending an email message having a training segment and an active feedback mechanism included with the message; and
at least one of prompting the recipient by the message to provide feedback through the feedback mechanism and automatically providing feedback that no response has been received when the recipient does not respond within a predetermined period of time.

19. The method of claim 18, wherein the message comprises a clickable link, the method further comprising accessing the training segment by the recipient clicking the clickable link.

20. The method of claim 19, wherein the active feedback mechanism comprises the clickable link, the method further comprising automatically notifying a training provider when the recipient has accessed the training segment by clicking the clickable link.

21. The method of claim 19, wherein the active feedback mechanism comprises the clickable link, the method further comprising automatically notifying a training provider when the recipient has postponed the training by clicking the clickable link.

22. The method of claim 18, wherein the message comprises an attachment, and the method further comprises including the training segment in the attachment.

23. The method of claim 18, wherein the method comprises automatically providing feedback that no response has been received when the recipient does not respond within the predetermined period of time, the method further comprising automatically sending contact information of the recipient to the training provider.

24. The method of claim 23, further comprising the training provider calling the recipient by phone to resolve concerns that are inhibiting the recipient from running the training segment.
